(19) United States
(12) Patent Application Publication
(10) Pub. No.: US 2010/0198737 A1
(43) Pub. Date: Aug. 5, 2010

(54) PATENTABLE SUBJECT MATTER AND DIRECTION PLATFORM

(75) Inventor: George J. Awad, Philadelphia, PA (US)

Correspondence Address: DESIGN IP, P.C., 5100 W. TILGHMAN STREET, SUITE 205, ALLENTOWN, PA, 18104, US

(73) Assignee: PATENT SCOUT, LLC, Philadelphia, PA (US)

(21) Appl. No.: 12/362,517

(22) Filed: Jan. 30, 2009

(51) Int. Cl. G06Q 99/00

(52) U.S. Cl. 705/310

(57) ABSTRACT

A computer-implemented interactive system and methods allowing for the generation of patentable subject matter analysis data representative of the likelihood of whether an invention, characterized through answers to a selected questionnaire, contains patentable subject matter are provided. In an illustrative implementation, an exemplary patentable subject matter environment comprises a patentable subject matter engine operable on a computing environment machine, and an instruction set having at least one instruction set to instruct the patentable subject matter engine to process data representative of one or more answers to a selected questionnaire which characterizes an invention to generate a patentable subject matter report providing a likelihood of whether the invention contains patentable subject matter according to a selected patentable subject matter analysis paradigm comprising a decision tree which provides guidance regarding the generation of the patentable subject matter report.

### BACKGROUND

The proliferation of the electronic communications technologies has allowed for mass delivery of electronic information and has availed the development and deployment of numerous electronic applications that allow various functions to be performed. Included in currently deployed applications are electronic banking, electronic healthcare transactions, online shopping, online music, and video/audio streaming to name a few. In general terms these applications can be deployed across a local and/or wide are computing environment depending on the context of the application and the types of users who are intended to use the applications. Further such applications can touch on various industries including the legal industry (e.g., a computing application to assist in the drafting of a will).

A number of information services have been deployed on the Internet that assist users to understand various legal principles and in some instances to assist users in preparing various legal documents. Hands down, one of the most complex legal specialties in the United States and across the globe is the practice of patent law. The complexity of patent law is derived in formulating laws that avail legal protections on various technologies (e.g., various types of inventions). In such context, patent laws, including US patent laws, are detailed, numerous, and ever changing to adapt to the pace of technology discovery. For example, in the late 1990s, with the proliferation of the Internet and e-commerce, a number of technology discoveries and applications were identified and developed that were not fully addressed by then existing United States patent laws. As a result, the American Inventor Protection Act was passed in 1999 which served to address the then shortcomings of US patent law as it pertained to these then nascent Internet technologies (e.g., business methods and business method platforms).

Under United States patent laws, an inventor may be granted patent rights if they can generally show that their invention 1) contains patentable subject matter, 2) is new and useful (has some utility), and 3) is non-obvious over existing prior art. These three pillars of US patent law can also be considered three major pitfalls given the complexity involved when analyzing if an inventor's invention satisfies these requirements. Moreover, these pillars are interrelated in various contexts and all must be met for patent rights to vest to the inventor on his/her invention. Often, these analyses are performed serially to avoid additional work. That is, if the patentable subject matter analysis yields a result that the invention might not contain patentable subject matter, the additional utility and non-obviousness analyses are generally performed since they are rendered moot. As such, the analysis surrounding whether an invention contains patentable subject matter is the penultimate starting point when considering protection of an invention under United States patent laws.

With current practices an inventor is generally required to contact and engage a patent professional (e.g., patent lawyer/patent agent) when considering whether to pursue patent protection on their invention(s). Such task can be extremely costly given the average fees charged by highly skilled patent professionals. Additionally, independent inventors (e.g. “garage inventor”) often are at a loss in how to locate a patent professional in their geographic area and/or whether the patent professional they have found has the technology background to best understand the inventor's invention. Although, the adage among patent professionals is that a skilled patent professional can counsel on the protection of any technology, in practice, it is more desirable and efficient for an inventor to work with a patent professional that has an education background and/or professional experience in the technology area covered by the inventor's invention.

Current Internet websites and applications and/or electronic applications directed to providing legal information about patentable subject matter provide static legal information. Specifically, current legal information applications provide a listing of various data sources (e.g., statutes, case law, sample patents, and exemplary scenarios) which an inventor is left to navigate through independently. Often, current solutions do not provide instructions on how to perform a patentable subject matter analysis. Furthermore, with current practices, inventors (e.g., participating users) are left to determine on their own or through the help of a costly patent professional the likelihood of whether their invention contains patentable subject matter (e.g., according to United States patent practice).

Current practices fall short of providing a comprehensive technology platform which is operable to generate, dynamically, customized information, generated from an inventor's answers to a selected questionnaire about the inventor's invention, regarding the likelihood of whether the inventor's invention contains patentable subject matter (e.g., according United States patent practice). With such a technology platform, inventors, now armed with customized patentable subject matter information about their invention, can more efficiently (e.g., cost and time) determine if they should pursue next steps along the patent protection path.

From the foregoing, it is appreciated that there exists a need for systems and methods that ameliorate the shortcomings of existing practices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The herein described systems and methods provide a computer-implemented interactive system and methods allowing for the generation of patentable subject matter analysis data representative of the likelihood of whether an invention, characterized through answers to a selected questionnaire, contains patentable subject matter. In an illustrative implementation, an exemplary patentable subject matter environment comprises a patentable subject matter engine operable on a computing environment machine, and an instruction set having at least one instruction set to instruct the patentable subject matter engine to process data representative of one or more answers to a selected questionnaire which characterizes an invention to generate a patentable subject matter report providing a likelihood of whether the invention contains patentable subject matter. In the illustrative implementation, the instruction set can comprise at least one instruction instructing the exemplary patentable subject matter engine to process the one or more questionnaire answers according to a selected patentable subject matter analysis paradigm comprising a decision tree which provides guidance regarding the generation of the patentable subject matter report.

In the illustrative implementation, the patentable subject matter environment can further comprise one or more data stores cooperating with the exemplary patentable subject matter engine comprising data representative comprising any of patentable subject matter report template data, patentable subject matter questionnaire data, and patent professional directory listing data.

In an illustrative operation, the exemplary patentable subject matter engine is operable to receive a request to determine the likelihood of whether an invention, as characterized by one or more answers to a selected questionnaire, contains patentable subject matter. In the illustrative operation, responsive to the received request, the exemplary patentable subject matter engine can transmit a selected questionnaire comprising at least one question according to the selected patentable subject matter paradigm, receive at least one answer (e.g., yes/no) to the one or more questionnaire questions characterizing an exemplary invention, and process the received at least one answer according to the selected patentable subject matter paradigm to generate a patentable subject matter report having data representative of the likelihood of whether the exemplary invention, as characterized by the at least one answer to the one or more questionnaire questions, contains patentable subject matter. In the illustrative operation, the exemplary patentable subject matter engine can dynamically generate the patentable subject matter report using one or more patentable subject matter report templates and/.or template sections.

The following description and the annexed drawings set forth in detail certain illustrative aspects of the subject matter. These aspects are indicative, however, of but a few of the various ways in which the subject matter can be employed and the claimed subject matter is intended to include all such aspects and their equivalents.

### BRIEF DESCRIPTION OF THE DRAWINGS

FIG. 1 is a block diagram of an exemplary computing environment in accordance with an illustrative implementation of the herein described systems and methods.

FIG. 2 is a block diagram of an exemplary networked computing environment in accordance with an illustrative implementation of the herein described systems and methods.

FIG. 3 is a block diagram showing the cooperation of exemplary components of an illustrative implementation in accordance with the herein described systems and methods.

FIG. 4 is a block diagram showing an illustrative block representation of an illustrative implementation of an exemplary patentable subject matter platform in accordance with the herein described systems and methods.

FIG. 5 is a block diagram of one or more cooperating components of an exemplary patentable subject matter report in accordance with the herein described systems and methods.

FIG. 6 is a flow diagram of illustrative processing performed to generate a patentable subject matter report in accordance with the herein described systems and methods; and

FIG. 7 is a flow diagram of illustrative processing performed to identify a patent professional in accordance with the herein described systems and methods.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative illustrations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

### Illustrative Computing Environment:

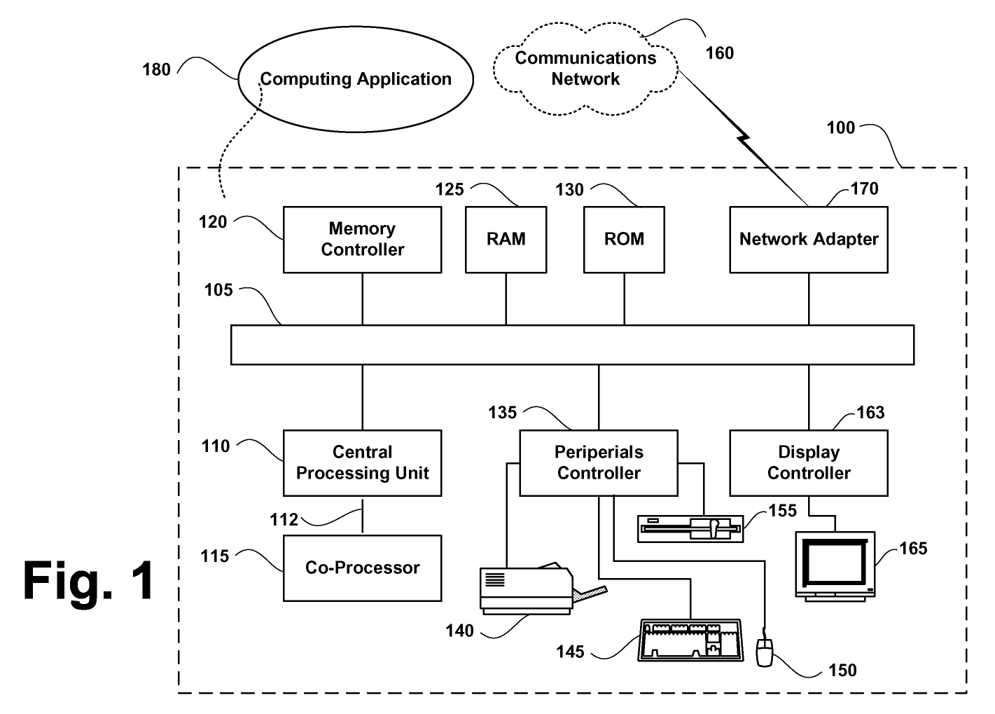

FIG. 1 depicts an exemplary computing system 100 in accordance with herein described system and methods. The computing system 100 is capable of executing a variety of computing applications 180. Computing application 180 can comprise a computing application, a computing applet, a computing program and other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to do work. In many known computer servers, workstations and personal computers CPU 110 is implemented by micro-electronic chips CPUs called microprocessors. A coprocessor 115 is an optional processor, distinct from the main CPU 110 that performs additional functions or assists the CPU 110. The CPU 110 may be connected to co-processor 115 through interconnect 112. One common type of coprocessor is the floating-point coprocessor, also called a numeric or math coprocessor, which is designed to perform numeric calculations faster and better than the general-purpose CPU 110.

In operation, the CPU 110 fetches, decodes, and executes instructions, and transfers information to and from other resources via the computer's main data-transfer path, system bus 105. Such a system bus connects the components in the computing system 100 and defines the medium for data exchange. Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, the computing system 100 can contain peripherals controller 135 responsible for communicating instructions from the CPU 110 to peripherals, such as, printer 140, keyboard 145, mouse 150, and data storage drive 155. Display 165, which is controlled by a display controller 163, is used to display visual output generated by the computing system 100. Such visual output may include text, graphics, animated graphics, audio, and video. The display controller 163 includes electronic components required to generate a video signal that is sent to display 165. Further, the computing system 100 can contain network adaptor 170 which may be used to connect the computing system 100 to an external communication network 160.

### Illustrative Computer Network Environment:

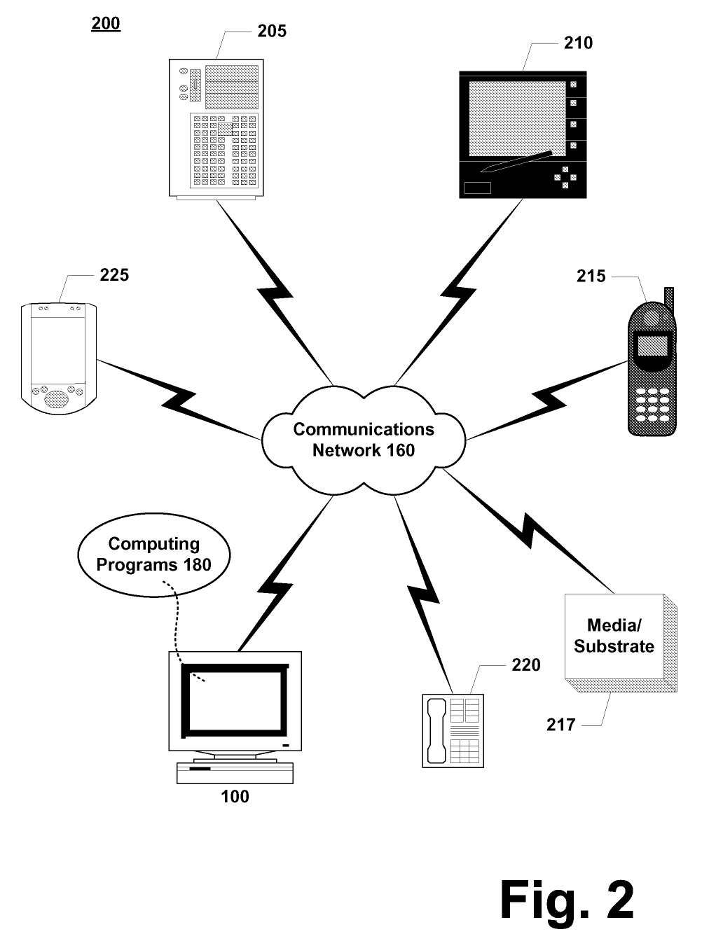

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2, server 205 may be interconnected via a communications network 160 (which may be either of, or a combination of a fixed-wire or wireless LAN, WAN, intranet, extranet, peer-to-peer network, virtual private network, the Internet, or other communications network) with a number of client computing environments such as tablet personal computer 210, mobile telephone 215, telephone 220, personal computer 100, media/substrate 217, personal digital assistant 225. In a network environment in which the communications network 160 is the Internet, for example, server 205 can be dedicated computing environment servers operable to process and communicate data to and from client computing environments 100, 210, 215, 217, 220, and 225 via any of a number of known protocols, such as, hypertext transfer protocol (HTTP), file transfer protocol (FTP), simple object access protocol (SOAP), or wireless application protocol (WAP). Additionally, networked computing environment 200 can utilize various data security protocols such as secured socket layer (SSL) or pretty good privacy (PGP). Each client computing environment 100, 210, 215, 217, 220, and 225 can be equipped with operating system 180 operable to support one or more computing applications, such as a web browser (not shown), or other graphical user interface (not shown), or a mobile desktop environment (not shown) to gain access to server computing environment 205.

In operation, a user (not shown) may interact with a computing application running on a client computing environments to obtain desired data and/or computing applications. The data and/or computing applications may be stored on server computing environment 205 and communicated to cooperating users through client computing environments 100, 210, 215, 217, 220, and 225, over exemplary communications network 160. A participating user may request access to specific data and applications housed in whole or in part on server computing environment 205. These data may be communicated between client computing environments 100, 210, 215, 217, 220, and 220 and server computing environments for processing and storage. Server computing environment 205 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

It is appreciated that media/substrate 217 can include but is not limited to various components operable to display sustainable content electronically, or otherwise (e.g., flexible and/or non-flexible liquid crystal displays, flexible and non-flexible LED displays, substrates operative to receive content presented by eco-friendly/recyclable materials). It is further appreciated that sustainable content can include but is not limited to electronic content displayable on the cooperating media/substrate that is illustratively powered by a sustainable power source (e.g., solar power, turbine power, or other sustainable power) and/or content that is presented on the media/substrate that is eco-friendly and/or recyclable (e.g., organic paint).

### Patentable Subject Matter Platform:

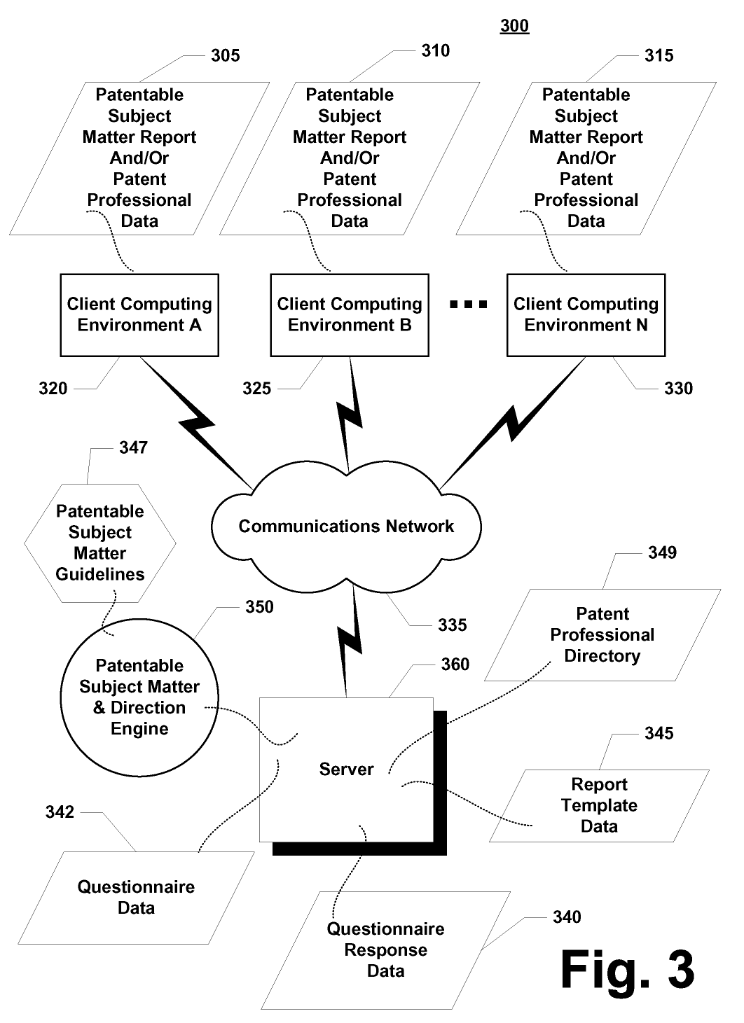

FIG. 3 shows an illustrative implementation of exemplary patentable subject matter environment 300. As is shown in FIG. 3, exemplary patentable subject matter environment 300 comprises client computing environment A 320, client computing environment 325 up to and including client computing environment N 330, communications network 335, server computing environment 360, patentable subject matter and direction engine 350, questionnaire response data 340, questionnaire data 365, report template data 345, patentable subject matter guidelines 355, and patent professional directory 370. Also, as is shown in FIG. 3, content management and distribution environment 300 can comprise patentable subject matter report and/or patent professional data 305, 310, and 315 that can be displayed, viewed, electronically transmitted, searched, copied, retrieved, annotated, navigated, and printed from client computing environments 320, 325, and 330, respectively.

In an illustrative operation, client computing environments 320, 325, and 330 can comprise one or more components that operatively communicate with server computing environment 360 over communications network 335 to provide questionnaire response data 340 (illustratively, questionnaire response data 340 can include answers to a patentable subject matter questionnaire, questionnaire data 35, that can be electronically communicated between server computing environment 360 and one or more of client computing environments 320, 325, and 350) and/or a request for patent professional directory listing data to server computing environment 360 and receive from server computing environment 360 patentable subject matter report and/or patent professional data 305, 310, and 315.

In the illustrative operation, patentable subject matter and direction engine 350 can execute one or more patentable subject matter guidelines 355 executable on server computing environment 360 to provide one or more instructions to server computing environment 360 to process questionnaire response data 340 to electronically generate patentable subject matter report data 305, 310, and 315 to the cooperating client computing environment (e.g., client computing environment 320, client computing environment 325, or client computing environment 335). As part of processing questionnaire response data 340 to generate patentable subject matter report data 305, 310, and 315, patentable subject matter and direction engine 350 can utilize a plurality of data sources including but not limited to, questionnaire data 365, questionnaire response data 340, and report template data.

Additionally, in the illustrative operation, patentable subject matter and direction engine 350 can process data representative of a request for a patent professional directory listing (e.g., provided by client computing environments 320, 325, or 330 to patentable subject matter and direction engine 350 operating on server computing environment 360). Responsive to the request for a patent professional directory listing, patentable subject matter and direction engine 350 can cooperate with patent professional directory data store 370 to retrieve one or more patent professional directory listings that are responsive to the received request. Also, as is shown in FIG. 3, client computing environments 320, 325, and 330 are capable of processing patentable subject matter report and/or patent professional data 305, 310, and 315 using an exemplary computing application (not shown) for display and interaction to one or more participating users and/or cooperating parties (not shown).

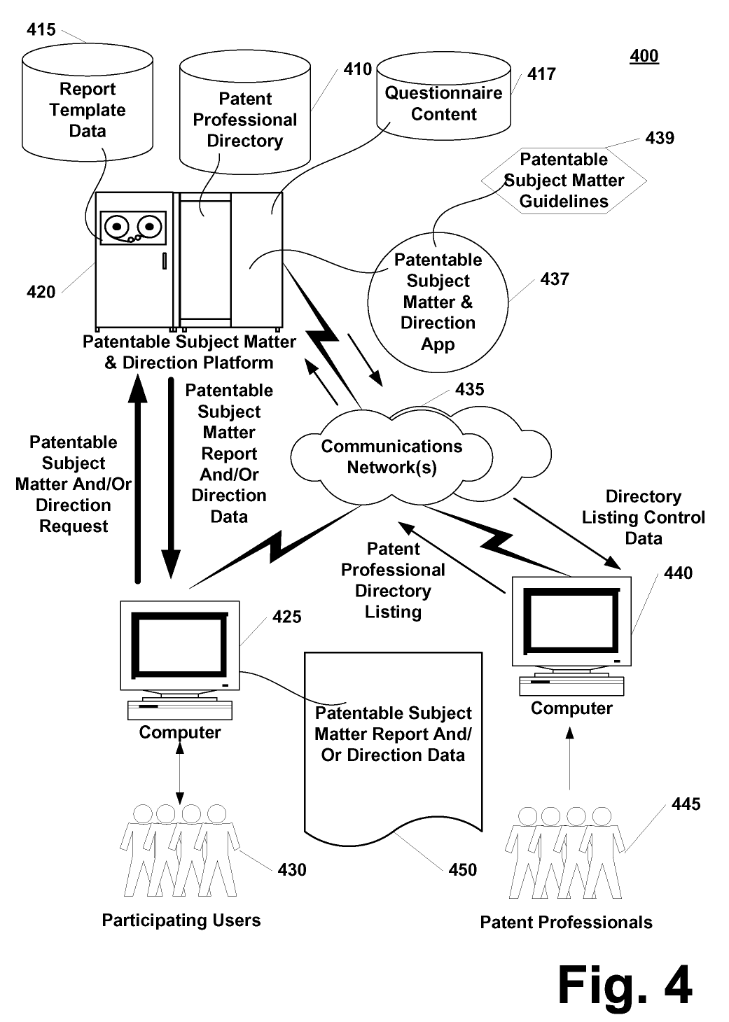

FIG. 4 shows a detailed illustrative implementation of a patentable subject matter and direction environment 400. As is shown in FIG. 4, exemplary patentable subject matter and direction environment 400 comprises patentable subject matter and direction platform 420, report template data store 415, questionnaire content data store 417, patent professional directory listing data store 410, patentable subject matter and direction application 437, patentable subject matter guidelines 439 (e.g., decision matrix providing guidance which patentable subject matter analysis report sections to include a customized patentable subject matter report based, at least in part, on the one or more answers to a selected patentable subject matter questionnaire), participating users 430 (e.g., inventors), participating user computing environment 425, patent professional computing environment 440, patent professionals 445.

Additionally, as is shown in FIG. 4, patentable subject matter and direction environment 400 can comprise patentable subject matter report and/or direction data 450 which can be operatively displayed on participating user computing environment 425. Further as is shown, participating users 430 can illustratively interface (e.g., providing one or more answers to a patentable subject matter questionnaire and/or requesting data on a patent professional by submitting a search query having one or more selected search criteria) with participating user computing environment 425 to trigger the generation of customized (i.e., based on the one or more answers provided by the participating user to the patentable subject matter questionnaire) patentable subject matter report and/or the retrieval of one or more patent professional directory listings (i.e., according to the submitted search request—search queries).

In an illustrative implementation, patentable subject matter and direction platform 420 can be operatively coupled to participating user computing environment 425, and electronically coupled to patent professionals computing environment 440 via communications network 435. In the illustrative implementation, communications network can comprise fixed-wire and/or wireless intranets, extranets, local area networks, wide area networks, and the Internet.

In an illustrative operation, exemplary patentable subject matter and direction platform 420 can receive one or more requests to generate a patentable subject matter report and/or to retrieve a patent professional directory listing from cooperating participating user computing environment 420 over communications network 435. Responsive to the one or more requests, and depending on the request, patentable subject matter report and direction platform 420 can operate to generate a customized patentable subject matter report (i.e., customized according to at least one answer received by the patentable subject matter and direction platform 420 from participating user computing environment 425 to one or more patentable subject matter questionnaire questions provided by patentable subject matter and direction platform 420) and/or retrieve a patent professional directory search listing that is responsive to one or more search criteria received as part of the request for a patent professional directory listing by patentable subject matter and direction platform 420.

In the illustrative operation patentable subject matter and direction platform 420 can process the received request using patentable subject matter and direction application 437 according to one or more patentable subject matter guidelines 439 to provide to a cooperating computing environment (e.g., participating user computing environment 425) one or more questions (e.g., a questionnaire having yes or no type questions regarding an invention—i.e., the development, disclosure, and make-up of the invention) retrieved from patentable subject matter questionnaire content data store 417. In the illustrative operation, patentable subject matter and direction platform 420 can receive at least one answer (e.g., the at least one answer characterizing at least on aspect of an invention—e.g., the development, disclosure, and make-up, of the invention) to the one or more provided questions and process the received at least one answer using patentable subject matter and direction application 437 according to one or more patentable subject matter guidelines 439.

In the illustrative operation, patentable subject matter and direction application 437 can process the received at least one answer according to a patentable subject matter analysis paradigm (e.g., a decision matrix) to identify one or more patentable subject matter report sections to include in customized patentable subject matter report 450 that patentable subject matter and direction application 437 generate and can cooperate with report template data store 415 to retrieve the one or more patentable subject matter report sections for inclusion in the customized patentable subject matter report 450. The generated customized patentable subject matter 450 report can then be communicated by patentable subject matter and direction platform to a cooperating computing environment (e.g., participating user computing environment 425) over communications network 435 for display, navigation, and sharing on the cooperating computing environment 425.

In an illustrative operation, patentable subject matter and direction platform 420 can receive one or more requests from a cooperating computing environment (e.g., participating user computing environment 425) to retrieve a patent professional director listing. Responsive to the request, patentable subject matter and direction platform 420 can utilize patentable subject matter and direction application 437 to retrieve one or more responsive patent professional directory listings from patent professional directory data store 410. In the illustrative implementation, the request for one or more patent professional directory listings can comprise one or more patent professional directory listing search query parameters (e.g., first name, last name, address, specialty, registration number, etc.) that can act to describe the patent professional directory listing of interest. In the illustrative operation, patentable subject matter and direction platform 420 can communicate the retrieved responsive one or more patent professional directory listings to a cooperating computing environment (e.g., participating user computing environment 425) for display, navigation, printing, and/or sharing.

In the herein described illustrative operations, participating users 430 can interface with participating user computing environment 425 (e.g., client computing environment, mobile device, etc.) through a computing application (e.g., content/web browser type computing application—not shown) to submit one or more requests for a patentable subject matter report and/or to retrieve one or more patent professional directory listings. In the illustrative operation, participating users 430 can view, navigate, print, and/or share responsive patentable subject matter report and/or patent professional directory listings 450 using one more components (not shown) of participating user computing environment 425.

In an illustrative operation, patentable subject matter and direction platform 420 can receive one or more requests to activate a customized patent professional directory listing. Responsive to the received activation request, patentable subject matter and direction platform 420 can operatively process the request to validate one or more credential data (e.g., patent professional's registration number, patent professional's e-mail address, or some other validation criteria) to provide access for and to activate a customized patent professional directory listing entry. In the illustrative operation, patentable subject matter and direction platform 420 can, upon validating the received request, receive a customized patent professional directory listing for storage in patent professional directory listing data store 410 for subsequent retrieval and/or processing.

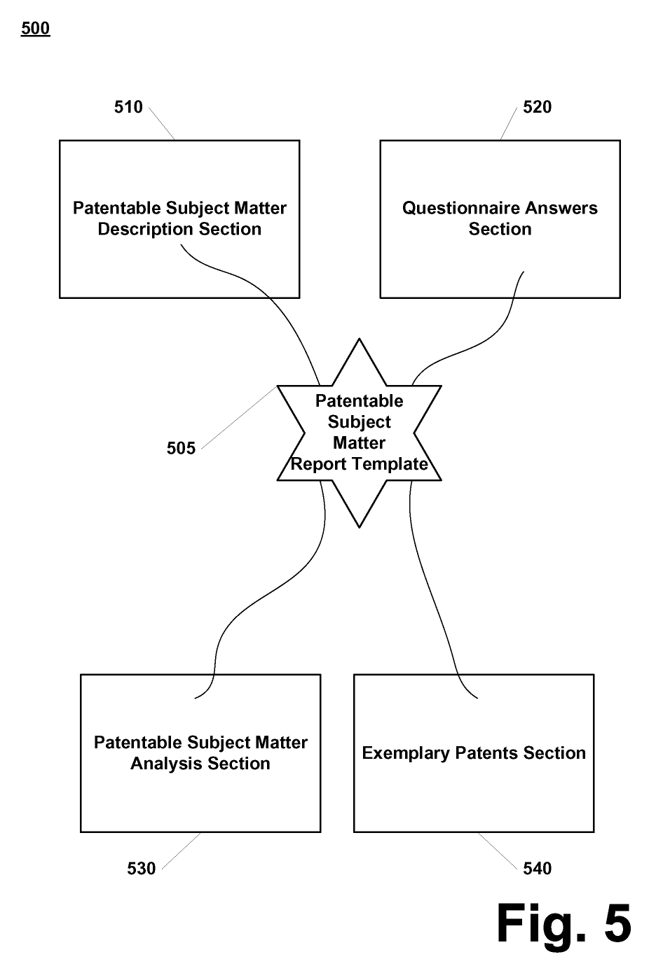

FIG. 5 shows an exemplary patentable subject matter report template data store 500 that can be utilized when generating a patentable subject matter report 450 of FIG. 4. As is shown in FIG. 5, in an illustrative implementation, exemplary patentable subject matter report template data store 500 comprises patentable subject matter report template 505 comprising one or more sections including but not limited to patentable subject matter description section 510, questionnaire answers section 520, patentable subject matter analysis section 530, and exemplary patents section 540.

In the illustrative implementation, patentable subject matter description section can comprise data representative of patentable subject matter information for one or more jurisdictions (e.g., what is considered to be patentable subject matter under United States practice). Further, in the illustrative implementation, questionnaires answers section 520 can comprise data representative of at least one answer to one or more questions from a selected patentable subject matter questionnaire. Also, as is shown in FIG. 5, patentable subject matter analysis section 530 can comprise one or more patentable subject matter analysis sections comprising data representative of the likelihood of whether an invention, as characterized by at least one answer to one or more questions of a patentable subject matter questionnaire (e.g., questionnaire answers section 520), contains patentable subject matter. Additionally, in the illustrative implementation, exemplary patent section 540 can comprise data representative of one or more exemplary patents for one or more jurisdictions (e.g., a sample chemistry composition United States issued patent).

In an illustrative operation, exemplary patentable subject matter data store 500 can operatively cooperate with a patentable subject matter and direction platform 420 of FIG. 4 to store one or more sections of a patentable subject matter analysis report comprising any of patentable subject matter description section 510, questionnaire answers section 520, patentable subject matter analysis section 530, and exemplary patents section 540. In the illustrative operation, according to a selected patentable subject matter analysis paradigm, patentable subject matter data store 500 can be utilized by patentable subject matter and direction platform 420 of FIG. 4 when generating an exemplary patentable subject matter report according to patentable subject matter report template 505. In the illustrative operation,

It is appreciated that although patentable subject matter report template 505 is shown to comprise exemplary sections (e.g., patentable subject matter description section 510, questionnaire answers section 520, patentable subject matter analysis section 530, and exemplary patents section 540) that such description is merely illustrative as patentable subject matter report template 505 can comprise various report sections above and beyond the described exemplary sections.

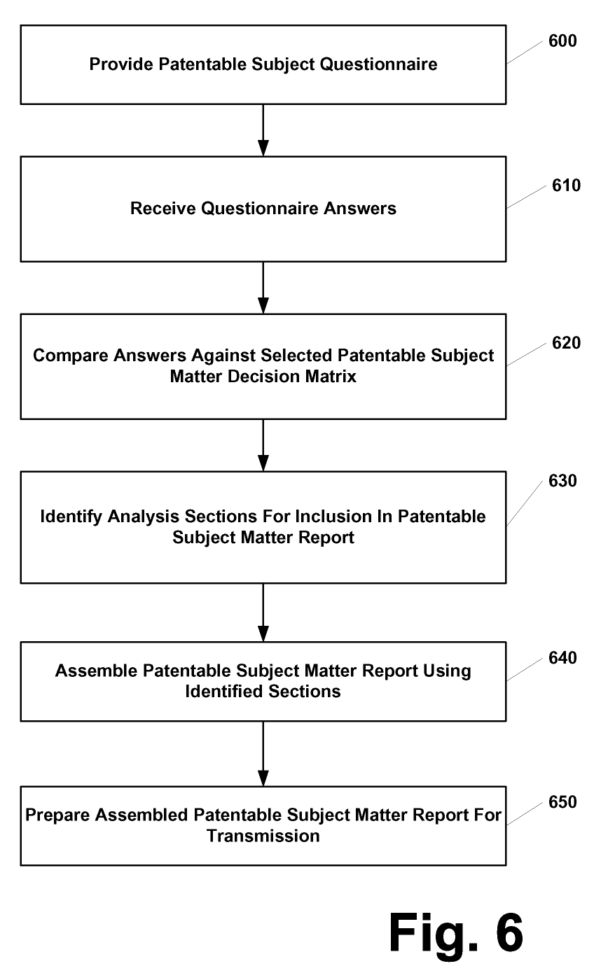

FIG. 6 shows exemplary processing performed by illustrative patentable subject matter and direction platform 420 of FIG. 4 when patentable subject matter analysis processing. As is shown, processing begins at block 600 where a patentable subject matter questionnaire is provided. From there, processing proceeds to block 610 where at least one questionnaire answer is received. The received at least one answer is compared against a selected patentable subject matter decision matrix at block 620. In an illustrative implementation, the patentable subject matter decision matrix can comprise an exemplary logic flow which details which patentable subject matter sections (e.g., already prepared) to include depending on the value of the received at least one questionnaire answer (e.g., whether the questionnaire answer is yes or no). Processing then proceeds to block 630 where one or more patentable subject matter analysis sections are identified for inclusion in a patentable subject matter report. The patentable subject matter report can then be assembled at block 640 using the identified patentable subject matter analysis sections. The assembled (e.g., electronically generated) patentable subject matter is then prepared for transmission at block 650.

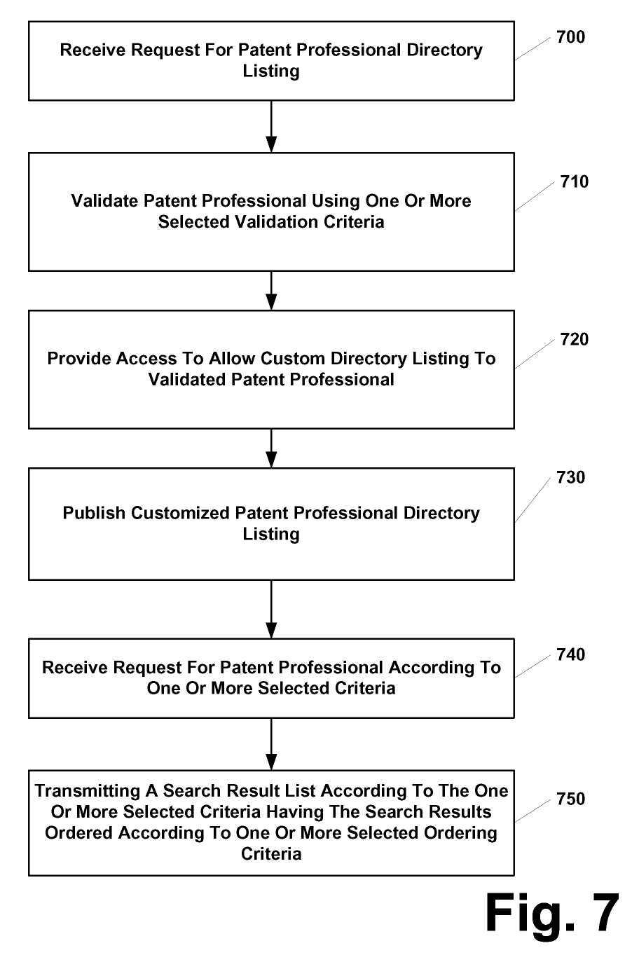

FIG. 7 shows exemplary processing performed by illustrative patentable subject matter and direction platform 400 of FIG. 4 when processing one or more requests from a patent professional to list a customized patent professional listing and to retrieve a patent professional directory listing according to one or more selected search criteria. As is shown, processing begins at block 700 where a request is received for a patent professional directory listing. Processing then proceeds to block 710 where a patent professional is validated according to one or more selected validation criteria (e.g., patent professional is required to submit a registration number to ensure that the patent professional's credentials are current). From there, processing proceeds to block 720 where access is provided to a patent professional to allow the patent professional to submit a customized (e.g., custom) patent professional directory listing.

The customized patent professional directory listing is then published at block 730. A request can then be received at block 740 where a request can be received for a patent professional directory listing according to one or more search criteria. In an illustrative implementation, exemplary search criteria can include but is not limited to: patent professional name (e.g., first and/or last), geographic search criteria, registration number search, and patent professional technology specialty.

The methods can be implemented by computer-executable instructions stored on one or more computer-readable media or conveyed by a signal of any suitable type. The methods can be implemented at least in part manually. The steps of the methods can be implemented by software or combinations of software and hardware and in any of the ways described above. The computer-executable instructions can be the same process executing on a single or a plurality of microprocessors or multiple processes executing on a single or a plurality of microprocessors. The methods can be repeated any number of times as needed and the steps of the methods can be performed in any suitable order.

The subject matter described herein can operate in the general context of computer-executable instructions, such as program modules, executed by one or more components. Generally, program modules include routines, programs, objects, data structures, etc., that perform particular tasks or implement particular abstract data types. Typically, the functionality of the program modules can be combined or distributed as desired. Although the description above relates generally to computer-executable instructions of a computer program that runs on a computer and/or computers, the user interfaces, methods and systems also can be implemented in combination with other program modules. Generally, program modules include routines, programs, components, data structures, etc. that perform particular tasks and/or implement particular abstract data types.

Moreover, the subject matter described herein can be practiced with most any suitable computer system configurations, including single-processor or multiprocessor computer systems, mini-computing devices, mainframe computers, personal computers, stand-alone computers, hand-held computing devices, wearable computing devices, microprocessor-based or programmable consumer electronics, and the like as well as distributed computing environments in which tasks are performed by remote processing devices that are linked through a communications network. In a distributed computing environment, program modules can be located in both local and remote memory storage devices. The methods and systems described herein can be embodied on a computer-readable medium having computer-executable instructions as well as signals (e.g., electronic signals) manufactured to transmit such information, for instance, on a network.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing some of the claims.

It is, of course, not possible to describe every conceivable combination of components or methodologies that fall within the claimed subject matter, and many further combinations and permutations of the subject matter are possible. While a particular feature may have been disclosed with respect to only one of several implementations, such feature can be combined with one or more other features of the other implementations of the subject matter as may be desired and advantageous for any given or particular application.

Moreover, it is to be appreciated that various aspects as described herein can be implemented on portable computing devices (e.g., field medical device), and other aspects can be implemented across distributed computing platforms (e.g., remote medicine, or research applications). Likewise, various aspects as described herein can be implemented as a set of services (e.g., modeling, predicting, analytics, etc.).

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods.

It should also be noted that the herein described systems and methods can be implemented in a variety of electronic environments (including both non-wireless and wireless computer environments), partial computing environments, and real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus can also be considered to be implemented as a computer-readable storage medium, configured with a computer program, where the storage medium so configured causes a computer to operate in a specific and predefined manner.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The herein described systems and methods may be better defined by the following exemplary claims.

What is claimed is:

1. A patentable subject matter system operable as one or more computing environment machine components comprising:
a patentable subject matter engine operable to receive data representative of at least one answer to one or more questions of a selected patentable subject matter questionnaire; and
an instruction set executing on the one or more computing environment machine components comprising at least one instruction to instruct the patentable subject matter engine to process data representative of at least one answer, characterizing an invention, to one or more questions of a selected patentable subject matter questionnaire according to a selected patentable subject matter analysis paradigm to electronically generate, using the processed at least one answer data, a patentable subject matter report having patentable subject matter analysis for the invention,
wherein the selected patentable subject matter analysis paradigm comprises a decision tree that is applied to the at least one received answer to provide at least one instruction to the patentable subject matter engine to select a patentable subject matter report section.

2. The system as recited in claim 1, further comprising one or more data stores operable to store data comprising patentable subject matter questionnaire data, patent subject matter guideline data, patentable subject matter questionnaire response data, patentable subject matter template data, and patent professional directory listing data.

3. The system as recited in claim 2, wherein the patentable subject matter engine is operable to receive a request for a patent professional listing according to one or more patent professional search queries and retrieve patent professional directory listing data from the one or more data stores responsive to the received one or more patent professional search queries.

4. The system as recited in claim 1, where the patentable subject matter report comprises one or more report sections including a patentable subject matter analysis report section.

5. The system as recited in claim 4, wherein the patentable subject matter questionnaire comprises one or more questions having a yes/no answer.

6. The system as recited in claim 1, wherein the patentable subject matter engine comprises a computing application.

7. The system as recited in claim 6, wherein the instruction set comprises a portion of the computing application.

8. The system as recited in claim 1, wherein the patentable subject matter engine electronically communicates the patentable subject matter questionnaire to one or more cooperating computing environments over a communications network.

9. The system as recited in claim 8, wherein the patentable subject matter engine is operable to electronically receive the at least one answer from the one or more cooperating computing environments over the communications network.

10. The system as recited in claim 9, wherein the patentable subject matter engine is operable to electronically communicate the generated patentable subject matter report to the one or more cooperating computing environments over the communications network.

11. A computer implemented method for transforming questionnaire answer data from a patentable subject matter questionnaire into a patentable subject matter report comprising:
receiving data representative of at least one answer to one or more questions of a patentable subject matter questionnaire, the at least one answer characterizing an invention;
applying a selected decision tree of an exemplary patentable subject matter analysis paradigm to the received data;
identifying one or more patentable subject matter report sections to retrieve from a data store based upon the application of the selected decision tree on the received data; and
generating a customized patentable subject matter report for the invention using the identified one or more patentable subject matter report sections.

12. The method as recited in claim 11, further comprising communicating the generated a customized patentable subject matter report to one or more cooperating computing environments.

13. The method as recited in claim 11, further comprising communicating a patentable subject matter questionnaire to one or more cooperating computing environments.

14. The method as recited in claim 13, further comprising receiving from one or more cooperating computing environments at least one answer of one or more questions of a patentable subject matter questionnaire.

15. The method as recited in claim 11, further comprising receiving a request to locate one or more patent professionals from a cooperating computing environment comprising one or more patent professional search query variables.

16. The method as recited in claim 15, further comprising responsive to the received request for a patent professional retrieving data from a cooperating patent professional directory listing data store patent professional directory listing data responsive to the received request.

17. The method as recited in claim 16, further comprising communicating the retrieved patent professional directory listing data to one or more cooperating computing environments.

18. The method as recited in claim 11, further comprising retrieving one or more patentable subject matter report templates for generating the customized patentable subject matter report.

19. The method as recited in claim 19, further comprising populating the retrieved one or more patentable subject matter report templates using the identified one or more patentable subject matter report sections.

20. A computer readable medium comprising computer readable instructions to instruct a computer to perform a method for the transformation of patentable subject matter questionnaire answer data into a customized patentable subject matter report comprising:
receiving data representative of at least one answer to one or more questions of a patentable subject matter questionnaire, the at least one answer characterizing an invention;
applying a selected decision tree of an exemplary patentable subject matter analysis paradigm to the received data;
identifying one or more patentable subject matter report sections to retrieve from a data store based upon the application of the selected decision tree on the received data; and
generating a patentable subject matter report for the invention using the identified one or more patentable subject matter report sections.
